(19) United States
(12) Patent Application Publication
(10) Pub. No.: US 2011/0152119 A1
(43) Pub. Date: Jun. 23, 2011

(54) Quantification Method of Biochemical Substances Using Ion Scattering Spectroscopy and Specific-Binding Efficiency Quantification Method of Biochemical Substances Using Ion Scattering Spectroscopy

(75) Inventors: Tae Geol Lee, Daejeon (KR); Dae Won Moon, Daejeon (KR); Hye geun Min, Daejeon (KR)

(73) Assignee: KOREA RESEARCH INSTITUTE OF STANDARDS AND SCIENCE, Daejeon (KR)

(21) Appl. No.: 13/059,445

(22) PCT Filed: Aug. 21, 2009
(86) PCT No.: PCT/KR2009/004657

§ 371 Date: Feb. 17, 2011

(30) Foreign Application Priority Data
Aug. 21, 2008 (KR) 10-2008-0081887
Aug. 12, 2009 (KR) 10-2009-0074209

(51) Int. Cl. C40B 30/04

(52) U.S. Cl. 506/9

(57) ABSTRACT

A method for direct quantification of the areal density (number per surface area of a substrate) of an analyte including a biochemical substance bound on the surface of a substrate and for direct quantification of the binding efficiency of biochemical substances is disclosed. Specifically, the areal density of an analyte including a biochemical substance bound on the surface of a substrate, and the binding efficiency between a first biochemical substance fixed on the substrate surface and a second biochemical substance is measured by ion scattering spectroscopy (ISS).

### TECHNICAL FIELD

The present invention relates to a direct quantification of an analyte including biochemical substances bound to a substrate using ion scattering spectroscopy, more particularly to a quantification of binding efficiency of biochemical substances.

### BACKGROUND ART

The development of biochips is a major thrust of the rapidly growing biotechnology industry, which encompasses genomics, proteomics, and pharmaceuticals, among other activities. Biochips are essentially miniaturized laboratories enabling the biomolecules present on the surface thereof to perform complex biochemical reactions on the occurring inside cells. These chips enable researchers to quickly screen large numbers of biological analytes for diagnosis and treatment of diseases.

Important factors with respect to improvement in accuracy, reliability and reproducibility of measurements using biochips include the quantification and quality control (QC) of the density and spacing of the organic functional groups of a self-assembled monolayer (SAM) on the surface of a biochip.

However, since organic films like the SAM are mainly composed of hydrocarbons, there is a difficulty in analyzing and quantifying them in molecular level.

At present, the only available quantitative analysis method for SAM is to chemically react the amine group with an aldehyde group and then count the number of the amine groups per unit area using a UV-visible spectrophotometer after detaching the aldehyde group or not [J. H. Moon, J. H. Kim, K.-J. Kim, T. H. Kang, B. Kim, C.-H. Kim, J. H. Hahn, J. W. Park, (1997) Langmuir 13, 4305].

However, the method of chemically reacting the functional group of SAM with a specific compound is limited in that the reaction efficiency cannot be always maintained at 100% and the method is not generally and universally applicable to SAMs having other functional groups, organic films, or the like. Until now, there is no method by which SAM or a biochemical substance directly bound to SAM can be observed through direct and absolute quantification.

Nanosurface analysis based on medium-energy ion scattering spectroscopy (MEIS), a low energy (dozens to hundreds of keV) version of ion scattering spectroscopy (ISS) [W.-K. Chu, J. W. Mayer, M.-A. Nicolet, 1997, Backscattering Spectrometry, Academic, New York San Francisco London], has been usefully utilized for the quantitative analysis of semiconductors, inorganic films, or the like because the surface sensitivity is superior enough to characterize the elemental composition and structure of thin film particularly in the atomic monolayer level [J. F. van der Veen, (1985) Surf Sci. Rep. 5, 199; E. J. van Loenen, A. E. M. J. Fischer, J. F. van der Veen, F. Legoues, (1985) Surf Sci. 154, 52; J. W. Frenken, J. F. van der Veen, (1985) Phys. Rev. Lett. 54, 134.; E. P. Gusev, H. C. Lu, T. Gustafsson, E. Garfunkel, (1995) Phys. Rev. B 52, 1759; P. Bailey, T. C. Q. Noakes, D. P. Woodruff, (1999) Surf Sci. 426, 358.].

The present invention is directed to applying the MEIS to a biochip film for quantification of biochemical substances such as organic films like SAMs, DNAs, proteins, etc.

In addition, the present invention is directed to directly analyzing the quantity and density of biochemical substances including organic molecules and biomolecules by means of the MEIS, and thereby measuring DNA-DNA binding efficiency, protein-protein interaction efficiency, or the like.

### DISCLOSURE OF INVENTION

### Technical Problem

An object of the present invention is to provide a method for quantitative and direct measurement of an analyte including a biochemical substance bound to a substrate, more particularly a method for accurate and direct measurement of a surface density of a biochemical substance including organic molecules and biomolecules on a biochip including a microarray.

Another object of the present invention is to provide a method for accurate and direct measurement of a binding efficiency of biochemical substances.

### Solution to Problem

Hereinafter, the embodiments of the present invention will be described in detail with reference to accompanying drawings.

A method for quantification of biochemical substances according to the present invention is characterized in that the areal density (number per area) of an analyte including biochemical substances bound on the surface of a substrate is determined by ion scattering spectroscopy (ISS).

The biochemical substance includes cell constituents, genetic materials, carbon compounds, and organic materials (including organometallic compounds) affecting metabolism, biosynthesis, material transport or signaling.

The analyte includes: a self-assembled monolayer (SAM) formed on the surface of the substrate; organic polymers, organometallic compounds, peptides, carbohydrates, proteins, protein complexes, lipids, metabolites, antigens, antibodies, enzymes, substrates, amino acids, aptamers, sugars, nucleic acids, nucleic acid fragments, peptide nucleic acids (PNAs), cell extracts, or a combination thereof fixed to the functional group of the SAM self-assembled on the substrate surface; nucleic acids complementarily binding to the nucleic acids fixed to the functional group of the SAM self-assembled on the substrate surface; proteins specifically binding to the proteins fixed to the functional group of the SAM self-assembled on the substrate surface; substrates specifically binding to the enzymes fixed to the functional group of the SAM self-assembled on the substrate surface; or antibodies specifically binding to the antigens fixed to the functional group of the SAM self-assembled on the substrate surface.

The analyte further includes: organic polymers, organometallic compounds, peptides, carbohydrates, proteins, protein complexes, lipids, metabolites, antigens, antibodies, enzymes, substrates, amino acids, aptamers, sugars, nucleic acids, nucleic acid fragments, PNAs, cell extracts, or a combination thereof bound at the surface of the substrate; nucleic acids complementarily binding to the nucleic acids bound at the substrate surface; proteins specifically binding to the proteins bound at the substrate surface; substrates specifically binding to the enzymes bound at the substrate surface; or antibodies specifically binding to the antigens bound at the substrate surface.

The ISS is medium-energy ion scattering spectroscopy (MEIS), more particularly MEIS using proton (H⁺). In the quantitative analysis and binding efficiency measurement of biochemical substances using MEIS according to the present invention, ions (including H⁺) are accelerated by applying an electric field of 60 to 150 keV, more preferably 100 keV.

More specifically, the method for quantification according to the present invention includes: a) injecting accelerated proton (H⁺) to a predetermined area of a substrate surface on which an analyte is present and detecting the energy of scattered proton and the amount of scattered proton thereof; b) computing the areal density (atoms per area) of a first element included in the analyte at the predetermined area from the detected energy of proton and amount of scattered proton; and c) computing the areal density (number per area) of the analyte from the areal density of the first element included in the analyte.

More specifically, the areal density of the first element is computed from the peak area of the first element from an MEIS spectrum of the detected energy of proton and amount of scattered proton, and the areal density of the analyte including the first element is computed from the areal density of the first element.

Preferably, the areal density of the first element is corrected using the peak area and areal density of an element included in the substrate (substrate element) with an accurately known composition.

More specifically, the areal density of the analyte is computed by dividing the areal density of the first element by a number of the first elements included in the analyte.

Preferably, the analyte is present in the form of a layer (either a single layer or a multiple layer in which the materials included in the analyte forms different layers) on the predetermined area of the substrate.

In consideration of detection sensitivity of ion spectroscopy, the method for quantification according to the present invention may further include, prior to a), contacting the analyte on the substrate with a metal precursor solution so that the metal ion of the metal precursor may bind to the analyte.

The analyte may be a SAM. In that case, the metal ion binds with sulfur included in the SAM. The metal precursor binding with sulfur includes a silver precursor and a gold precursor. The first element employed to measure the areal density of the SAM may be a metal binding with sulfur.

The analyte may be a nucleic acid, and the first element may be P. Assuming that each nucleic acid strand consists of N-mer (N is a natural number 1 or larger) and that each mer contains M P's (M is a natural number 1 or larger), the areal density of the nucleic acid (strand) is computed by dividing the areal density of the first element P by M×N.

The substrate may be a semiconductor single crystal substrate including a silicon single crystal substrate, a semiconductor single crystal substrate having a surface oxide layer, an amorphous substrate including a glass substrate, a metal oxide single crystal substrate including a silica single crystal substrate, or a laminated substrate thereof. Preferably, the injection of proton (H⁺) in a) is carried out along a predetermined crystal direction on the basis of the crystal structure of the single crystal. Preferably, the injection is carried out along a low index direction such as [111].

In the method for quantification of binding of biochemical substances according to the present invention, the areal density of a biochemical substance is computed as described above and the areal density of another biochemical substance binding thereto is computed. Then, the binding efficiency is determined from the proportion of the two areal densities.

Specifically, in the method for quantification of binding of biochemical substances according to the present invention, the areal density of a first biochemical substance fixed to the surface of a substrate is measured using ISS and the areal density of a second biochemical substance binding to the first biochemical substance is determined. Then, the areal density of the second biochemical substance is divided by the areal density of the first biochemical substance to compute the binding efficiency between the first biochemical substance and the second biochemical substances.

Specifically, the ISS is MEIS, more particularly MEIS using proton (H⁺).

More specifically, the method for measurement of binding according to the present invention includes: a1) injecting accelerated proton (H⁺) to a predetermined area of a substrate surface on which a first biochemical substance is present and detecting the energy of scattered proton and the amount of scattered proton thereof; b1) computing the areal density (atoms per area) of a second element included in the first biochemical substance at the predetermined area from the detected energy of proton and amount of scattered proton; c1) computing the areal density (number per area) of the first biochemical substance from the areal density of the second element included in the first biochemical substance; d1) injecting accelerated proton (H⁺) to the predetermined area of the substrate surface on which the first biochemical substance in contact with a second biochemical substance is present, and detecting the energy of scattered proton and the amount of scattered proton thereof; e1) computing the areal density (atoms per area) of a third element included in the second biochemical substance at the predetermined area from the detected energy of proton and amount of scattered proton; f1) computing the areal density (number per area) of the second biochemical substance from the areal density of the third element included in the second biochemical substance; and g1) computing the binding efficiency between the first biochemical substance and the second biochemical substance by dividing the areal density of the second biochemical substance by the areal density of the first biochemical substance.

More specifically, in b1), the areal density of the second element is computed from the peak area of the second element from an MEIS spectrum of the detected energy of proton and amount of scattered proton, and the areal density of the first biochemical substance including the second element is computed from the areal density of the second element.

The areal density of the first biochemical substance is computed by dividing the areal density of the second element by a number of the second element included in the first biochemical substance.

In d1), the areal density of the third element is computed from the peak area of the third element from an MEIS spectrum of the detected energy of proton and amount of scattered proton, and the areal density of the second biochemical substance including the third element is computed from the areal density of the third element.

The areal density of the second biochemical substance is computed by dividing the areal density of the third element by a number of the third element included in the second biochemical substance.

The second element and the third element may be the same element present in both the first biochemical substance and the second biochemical substance.

In another embodiment, the second element and the third element may be different from each other, and one element selected from the second element and the third element may be present only in the first biochemical substance or the second biochemical substance.

The first biochemical substance includes: a SAM formed on the surface of the substrate; or organic polymers, organometallic compounds, peptides, carbohydrates, proteins, protein complexes, lipids, metabolites, antigens, antibodies, enzymes, substrates, amino acids, aptamers, sugars, nucleic acids, nucleic acid fragments, PNAs, cell extracts, or a combination thereof fixed to the functional group of the SAM self-assembled on the substrate surface.

The first biochemical substance also includes organic polymers, organometallic compounds, peptides, carbohydrates, proteins, protein complexes, lipids, metabolites, antigens, antibodies, enzymes, substrates, amino acids, aptamers, sugars, nucleic acids, nucleic acid fragments, PNAs, cell extracts, or a combination thereof binding to the surface of the substrate.

The binding between the first biochemical substance and the second biochemical substance may be a specific binding such as enzyme-substrate, antigen-antibody, protein-protein or nucleic acid-nucleic acid binding.

### Advantageous Effects of Invention

An organic self-assembled monolayer (SAM), which serves as a platform of a biochip, plays a role of fixing a substrate supporting biomolecules for screening and testing of a biological analyte, or concerts a biological signal into an electrical or optical signal. The method for quantification of a biochemical substance according to the present invention is advantageous in that the surface density of the organic SAM itself, functional groups present on the SAM, DNAs fixed to the functional groups, DNAs binding to the fixed DNAs, proteins fixed to the functional groups, or proteins binding to the fixed proteins may be accurately quantified. As a result, a biochip enabling quality control can be manufactured, and performance reproducibility, diagnosis accuracy and reliability of a biochip can be improved remarkably.

Further, the method for quantification of a biochemical substance according to the present invention is advantageous in that it is possible to measure the absolute quantity of biomolecules fixed on a biochip, such as proteins, PNAs, DNAs, etc., and to measure the binding efficiency of the fixed biomolecules with external biomolecules.

### BRIEF DESCRIPTION OF DRAWINGS

The above and other objects, features and advantages of the present invention will become apparent from the following description of preferred embodiments given in conjunction with the accompanying drawings, in which:

FIG. 1 illustrates an exemplary apparatus for carrying out medium-energy ion scattering spectroscopy (MEIS) according to an embodiment of the present invention.

FIG. 2 shows an MEIS measurement result of a self-assembled monolayer (SAM). FIG. 2 (a) schematically shows a binding between Ag and S. FIG. 2 (b) is a depth profile showing relative elemental composition at each depth. FIG. 2 (c) is an MEIS spectrum of Ag-bound 3-mercaptopropyltrimethoxysilane SAM. In FIG. 2 (c), the solid line represents values computed by Kido simulation.

FIG. 3 shows an MEIS measurement result using a PNA biochip. FIG. 3 (a) schematically shows PNA labeled with 2-bromobenzonic acid fixed on epoxy SAM and a binding thereof with DNA. FIG. 3 (b) is an MEIS spectrum of a PNA biochip. In FIG. 3 (b), the solid line represents values computed by Kido simulation.

FIG. 4 shows MEIS spectrums of a protein biochip prepared in Preparation Example 2. FIG. 4 (a) schematically shows caspase-3 dimer protein fixed on a chip and shows an MEIS spectrum thereof. FIG. 4 (b) schematically shows a binding between caspase-3 dimer protein and BIR-23 protein and shows an MEIS spectrum thereof. FIG. 4 (c) schematically shows BIR-23 protein fixed on a chip and an MEIS spectrum thereof. FIG. 4 (d) schematically shows a binding between BIR-23 protein and caspase-3 protein and shows an MEIS spectrum thereof. In FIG. 4, the solid line represents values computed by Kido simulation.

FIG. 5 schematically shows a DNA microarray prepared in Preparation Example 3.

FIG. 6 shows MEIS spectrums obtained at four spots of a DNA microarray prepared in Preparation Example 3. FIG. 6 (a) shows an MEIS spectrum of a DNA microarray on which 25-mer DNA is sprayed. FIG. 6 (b) shows an MEIS spectrum of a DNA microarray on which 15-mer DNA is sprayed. In FIG. 6, the solid line represents values computed by Kido simulation.

FIG. 7 shows MEIS spectrums of a DNA chip prepared in Preparation Example 4. FIG. 7 (a) shows an MEIS spectrum of a fixed probe DNA. FIG. 7 (b) shows an MEIS spectrum for a binding of the probe DNA with DNA complementary thereto. In FIG. 7, the solid line represents values computed by Kido simulation.

### MODE FOR THE INVENTION

The following examples are for illustrative purposes only and not intended to limit the scope of the present invention. Accordingly, the present invention is not limited by the following examples but may be embodied in different forms.

Unless otherwise defined, all terms (including technical and scientific terms) used herein have the same meaning as commonly understood by one of ordinary skill in the art. Details of well-known features and techniques may be omitted to avoid unnecessarily obscuring the present invention.

### Preparation Example 1

### Preparation of MPTMS Self-Assembled Monolayer (SAM) Substrate

3-Mercaptopropyltrimethoxysilane (MPTMS) SAM having a thiol (—SH) functional group was formed on a SiO₂ substrate washed with super-piranha solution. The substrate with the MPTMS SAM formed thereon will be hereinafter referred to as a silicon wafer (I) having a thiol (—SH) surface.

After forming the MPTMS SAM, to improve medium-energy ion scattering spectroscopy (MEIS) measurement sensitivity, the substrate with the MPTMS SAM formed thereon (silicon wafer (I) having a thiol surface) was immersed in 1 mM AgNO 3 ethanol solution for 5 minutes so that the sensitive metal element Ag could bind one to one with S.

### Preparation Example 2

### Preparation of Protein Chip

The silicon wafer (I) having a thiol (—SH) surface was treated at room temperature with dimethylformamide (DMF) solution containing 100 mM N,N′-disuccinimidyl carbonate (DSC) and 100 mM N,N-diisopropylethylamine (DIEA) for 1 hour to prepare a silicon wafer (II) having an N-hydroxysuccinimidyl carbamate (NHS-carbamate) surface. The silicon wafer (II) was washed with distilled water and ethanol, dried using nitrogen gas, and stored in a desiccator.

Seleno-BIR-23 protein (a protein obtained by substituting the methionine residue of BIR-23 protein with a selenomethionine residue), produced in large scale using E. coli and purified by adsorption chromatography, was diluted with buffer solution (50 mM Tris-HCl, pH 7.5) to prepare a diluted seleno-BIR-23 protein solution with a final concentration of 100 ug/ml. The methionine residue of seleno-caspase-3 protein (a protein obtained by substituting the methionine residue of caspase-3 protein with a selenomethionine residue) was diluted with buffer solution (50 mM Tris-HCl, pH 7.5) to prepare a diluted seleno-caspase-3 protein solution with a final concentration of 100 ug/ml.

The diluted seleno-BIR-23 protein solution was applied on the surface of the silicon wafer (II). After fixing the protein to the wafer surface through a reaction at room temperature for 3 hours, unreacted NHS-carbamate group on the surface was inactivated by treating with 100 mM ethanolamine at pH 8.5. Then, a seleno-BIR-23 protein chip was prepared by washing with distilled water.

Similarly, the diluted seleno-caspase-3 protein solution was applied on the surface of the silicon wafer (II). After fixing the protein to the wafer surface through a reaction at room temperature for 3 hours, unreacted NHS-carbamate group on the surface was inactivated by treating with 100 mM ethanolamine at pH 8.5. Then, a seleno-caspase-3 protein chip was prepared by washing with distilled water.

Some of the prepared protein chips (seleno-BIR-23 protein chip or seleno-caspase-3 protein chip) were used for experiment without any treatment. Others were subjected to treatment prior to experiment. For example, the seleno-BIR-23 protein chip was treated with the diluted seleno-caspase-3 protein solution, and the seleno-caspase-3 protein chip was treated with the diluted seleno-BIR-23 protein solution. Then, the binding efficiency of the proteins was compared.

### Preparation Example 3

### Preparation of DNA Microarray

An ethanol solution containing 20 wt % 3-aminopropyltriethoxysilane (GAPS) was spin-coated on a silicon wafer washed with super-piranha solution. After washing with deionized (DI) water followed by drying, a silicon wafer with GAPS SAM formed thereon was obtained.

DNA solution was prepared from 100 uM oligo stock (25-mer or 15-mer): 9 mM polyethylene glycol (PEG) in 25 mM NaHCO₃ buffer (pH 8.0): 100% formamide=1:1:2 (v/v/v). Finally, 25 uM oligo 20% formamide in 2.25 mM PEG NaHCO₃ buffer was obtained.

A DNA microarray was prepared by spraying using a spotter (Cartesian pisys 5500A spotter) and four pins (Telecam SMP3 pin). The spot size was 100 um, and the spacing between the spots was 250 um. The total number of spots was 15×15×4. After the preparation, the DNA microarray was immobilized in a chamber of 70° C. and relative humidity (RH) 40% for 1 hour, and washed with DI water.

### Preparation Example 4

### Preparation of DNA Chip

Single-stranded synthetic DNA with an amine group substituted at 5′-position (5′-amine-TCCAGCAGATCCATGAGCAAAAGCTAA-3′) was dissolved in distilled water to prepare a diluted DNA solution with a final concentration of 100 uM.

Plasma polymerized ethylenediamine having an amine group was deposited on a silicon wafer washed with piranha solution by means of plasma deposition. Through 2 minutes of deposition under the condition of 2 W, ethylenediamine film was prepared with a final thickness of several nanometers. For details about the deposition process, please refer to J. Kim, H. Park, D. Young, S. Kim, (2003) Anal. Biochem. 313, 41.

A silicon wafer (II) was prepared by directly surface-treating the resultant ethylenediamine film with NHS-carbamate as in Preparation Example 2.

The diluted DNA solution was added and DNA was fixed on the silicon wafer (II) with the ethylenediamine film formed thereon by treating at room temperature for 3 hours. Then, a single-strand DNA chip (III) was prepared by inactivating unreacted NHS-carbamate group on the surface using 100 mM ethanolamine (pH 8.5) and then washing with distilled water.

In a similar manner, a double-strand DNA chip (IV) was prepared by inducing hybridization using DNA having a complementary base sequence.

Specifically, the base sequence of the complementary DNA is 5′-TTAGCTTTTGCTCATGGATCTGCTGGA-3′. The DNA was dissolved in distilled water to a concentration of 100 uM and 20 mM Mg₂⁺ ion was added to enhance hybridization efficiency. The diluted solution of the complementary DNA was reacted at room temperature with the single-strand DNA chip (III) for 3 hours to induce the formation of double-stranded DNA. After washing with distilled water and ethanol, the resultant double-strand DNA chip (IV) was dried using nitrogen gas.

Quantification of biochemical substances using ISS according to the present invention was carried out for the samples prepared in the foregoing examples.

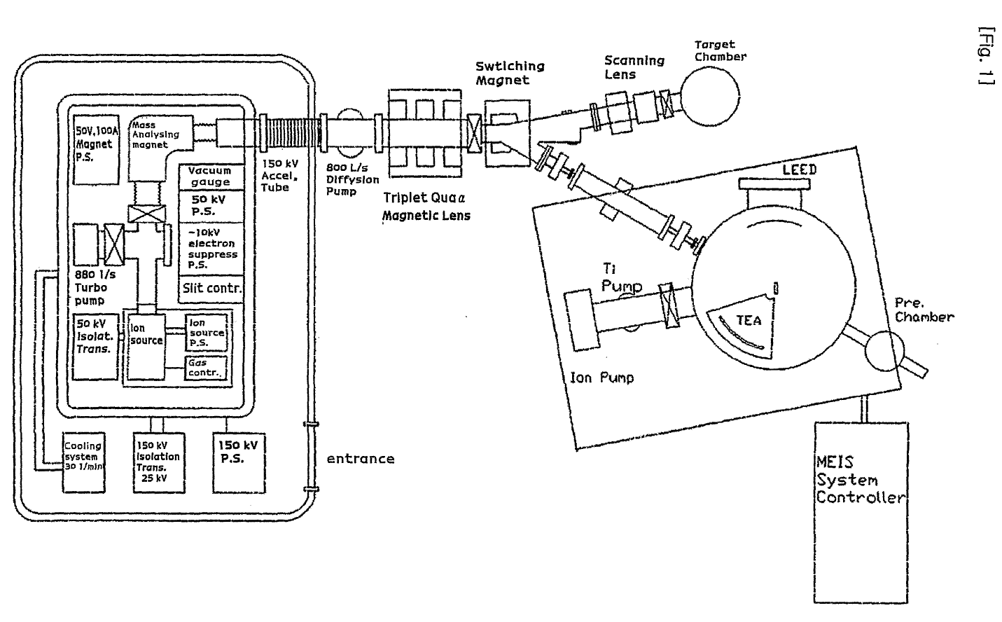

FIG. 1 illustrates an MEIS apparatus equipped with a toroidal electrostatic analyzer. According to MEIS measurement, electron energy loss of H⁺ ion beam accelerated at 100 keV was within hundreds of eV/nm. The energy resolution of about 0.1% corresponds to a depth of a single atomic layer.

For 2-dimensional analysis, H⁺ ion beam was injected to a constant area (1×0.25 mm²). The H⁺ ion injected in a [111] direction of a (011) surface of a silicon wafer was scattered in the direction with a scattering angle of 125°. From the resultant MEIS spectrum, a depth profile of the elements in the respective layers was obtained using the Kido ion scattering simulation program.

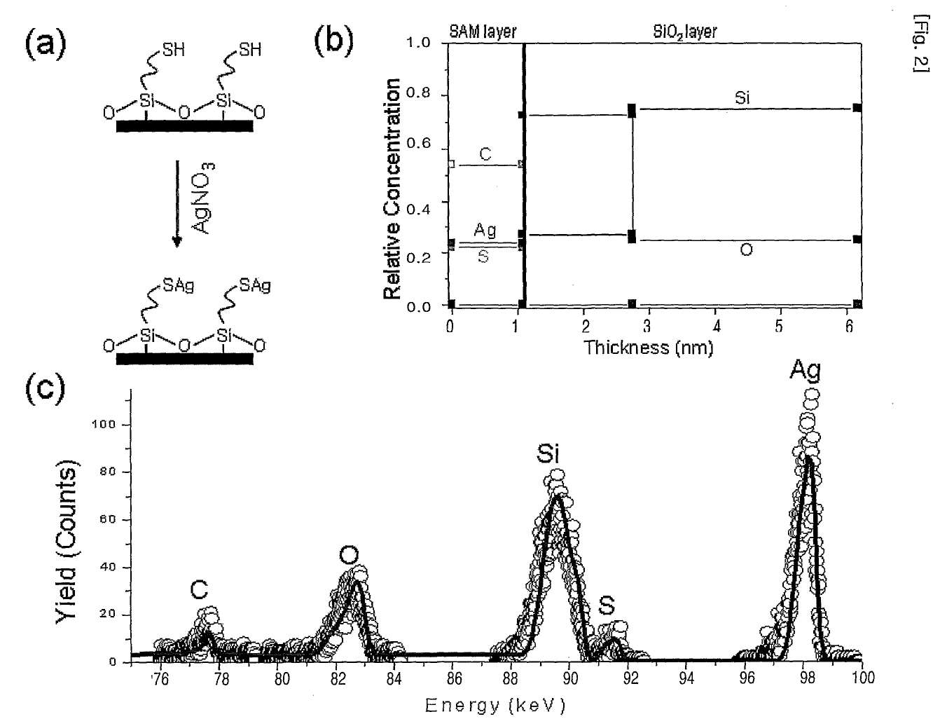

FIG. 2 (a) schematically shows the MPTMS SAM surface-treated with Ag in Preparation Example 1. FIG. 2 (b) is a depth profile showing relative elemental composition at each depth. The SAM was about 1.1 nm thick, which is similar to the length of the MPTMS ligand molecule. FIG. 2 (c) shows a spectrum (red curve) obtained from Kido ion scattering simulation of the MEIS data (black circle) of Ag-treated MPTMS SAM and the energy and amount of H⁺ scattered from each layer.

Since the exact composition of the substrate, i.e. a silicon substrate or a silicon substrate with a silicon oxide film formed thereon, is known, the areal density of each element may be calculated by correcting the peak area of other elements using the areal density of the substrate element (e.g., elemental silicon). For this purpose, channeling and blocking were considered to remove the peaks from the substrate (e.g., silicon crystal). With the help of the Kido ion scattering simulation program, the composition and areal density can be computed easily with a depth resolution not greater than several Å. The Kido simulation is carried out as follows. The energy of the incident H⁺ ion, incident angle, elemental composition of each layer, stopping power, or the like are input as input values. The energy of the H⁺ ion scattered from each layer, energy straggling, scattering cross-section, or the like are obtained as output values. For details about the Kido simulation procedure, please refer to Y. Kido, M. Kakeno, K. Yamada, J. Kawamoto, H. Ohsawa, T. Kawakami, (1985) J. Appl. Phys. 58, 3044; Y. Kido, J. Kawamoto, (1987) J. Appl. Phys. 61, 956; Y. Kido, T. Koshikawa, (1990) J. Appl. Phys. 67, 187.

The areas of the Ag, S, Si, O and C peaks measured in FIG. 2 (c) are their areal density, and the total quantity of each element may be calculated therefrom. The areal density of S and Ag is 6.15×10¹⁴ atoms/cm² and 6.65×10¹⁴ atoms/cm², respectively. Although there is an error of about 7.5%, it may be viewed as one-to-one correspondence since the MEIS analysis allows an error up to 10%.

Since the SAM of FIG. 2 (a) has a two-dimensional structure, the areal density of Ag and S can be directly interpreted as the surface density (number per area) of the SAM.

In case of a SAM comprising sulfur only as that of Preparation Example 1, the density of S can be directly computed without additional binding with a metal element. Then, the surface density of a functional group, a SAM having a functional group, or a biochemical substance specifically binding to a functional group can be calculated therefrom.

Through a binding with a metal element, which exhibits one-to-one correspondence with an analyte, like the S—Ag binding of the MPTMS SAM of Preparation Example 1, MEIS measurement sensitivity may be further enhanced so that the surface density of a SAM with a smaller density may be computed. This enables an accurate, controlled computation of the surface density of a SAM mixed with a ligand having a different functional group.

As shown in Preparation Example 1 and FIG. 2, the measurement using MEIS may be a very useful quantification method particularly for an organic film or a biofilm including highly sensitive elements.

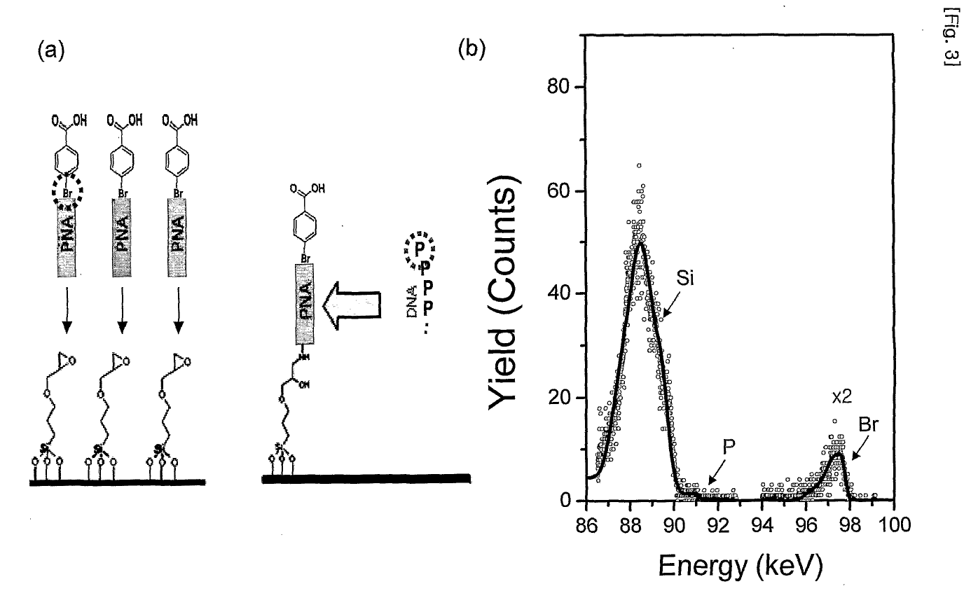

FIG. 3 shows a result of measuring the areal density of biomolecules fixed on a biochip.

FIG. 3 (a) schematically shows a biochip in which PNA labeled with 2-bromobenzonic acid fixed on epoxy SAM.

Because each PNA has one Br atom, the areal density of the PNA fixed on the SAM can be accurately computed from the quantification of Br. As indicated in the MEIS spectrum of FIG. 3 (b), the Br peak is enlarged by 2 times (×2). From FIG. 3 (b), it can be seen that the areal density of Br is 1.25×10¹⁴ atoms/cm² and that the density of PNA is 1.25×10¹⁴/cm².

Similarly, using the seleno-BIR-23 protein chip and the seleno-caspase-3 protein chip prepared in Preparation Example 2, in which the proteins are bound to the SAM, the absolute quantity of the bound proteins can be quantitatively determined.

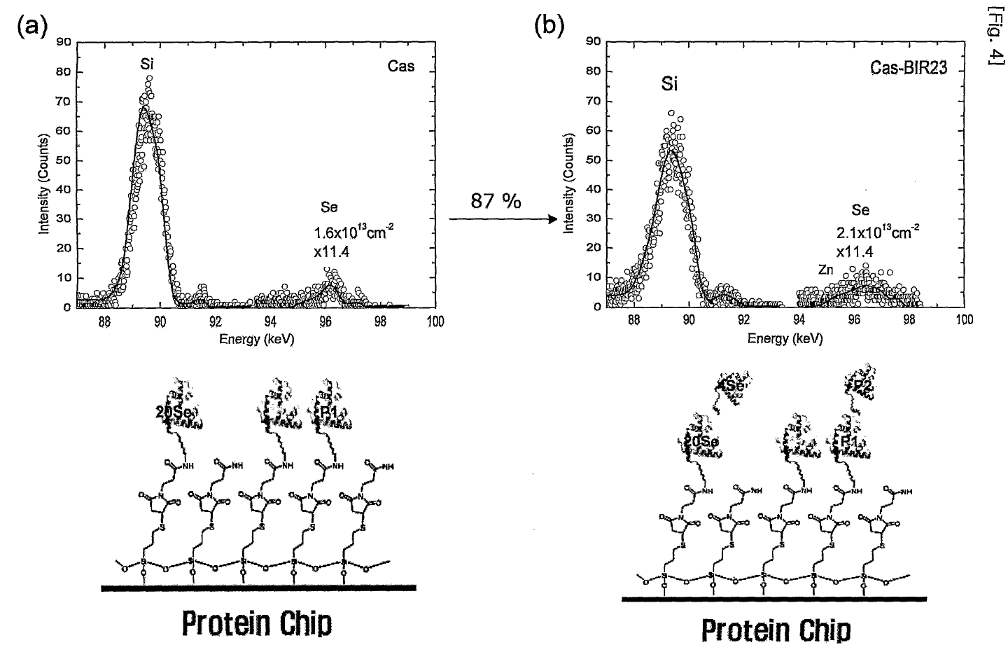

FIG. 4 shows MEIS spectrums of a protein biochip prepared in Preparation Example 2 and curves fitted by means of Kido ion scattering simulation.

FIG. 4 (a) shows an MEIS spectrum obtained from a seleno-caspase-3 protein chip. FIG. 4 (b) shows an MEIS spectrum obtained from a seleno-caspase-3 protein chip by adding diluted seleno-BIR-23 solution to bind caspase-3 protein and BIR-23 protein. In FIG. 4 (a) and FIG. 4 (b), the Se peak is enlarged by 11.4 times (×11.4).

Each caspase-3 protein contains ten Se atoms. From FIG. 4 (a), it can be seen that the surface density of the caspase-3 dimer protein is 1.53×10¹²/cm².

FIG. 4 (b) shows an MEIS spectrum of a sample obtained by binding BIR-23 protein each containing four Se atoms on a seleno-caspase-3 protein chip. As seen in FIG. 4 (b), the Se peak grows with the binding of BIR-23 protein. The areal density of BIR-23 protein may be computed by subtracting the Se areal density of FIG. 4 (a) from the Se areal density of FIG. 4 (b).

More specifically, by subtracting the Se areal density of FIG. 4 (a), 1.53×10¹³ atoms/cm², from the Se areal density of FIG. 4 (b), 2.06×10¹³ atoms/cm², 0.53×10¹³ atoms/cm² is obtained. Since each BIR-23 protein contains four Se atoms, the areal density of BIR-23 protein bound to the protein chip is 1.33×10¹²/cm².

As a result, the binding efficiency between caspase-3 protein and BIR-23 protein on the seleno-caspase-3 protein chip is computed as 1.33×10¹²/cm²/1.53×10¹²/cm²×100=87%.

MEIS spectrum was measured with BIR-23 protein fixed on the protein chip and using caspase-3 as a protein binding thereto.

FIG. 4 (c) shows an MEIS spectrum obtained from a seleno-caspase-3 protein chip. FIG. 4 (d) shows an MEIS spectrum obtained from a seleno-BIR-23 protein chip by adding diluted seleno-caspase-3 solution to bind BIR-23 protein and caspase-3 protein. In FIG. 4 (c) and FIG. 4 (d), the Se peak is enlarged by 11.4 times (×11.4).

The Se areal density is computed as 2.2×10¹³ atoms/cm² from the MEIS spectrum of FIG. 4 (c). Since each BIR-23 protein contains four Se atoms, the areal density of BIR-23 protein fixed on the seleno-BIR-23 protein chip is 5.5×10¹² atoms/cm².

Further, it can be seen that the BIR-23 protein is fixed more easily and effectively on the MPTMS SAM than the caspase-3 protein.

FIG. 4 (d) shows an MEIS spectrum of a sample obtained by binding BIR-23 protein and caspase-3 protein by adding diluted seleno-caspase-3 solution to the seleno-BIR-23 protein chip. Similarly to FIG. 4 (a) and FIG. 4 (b), the areal density of bound caspase-3 protein may be computed by subtracting the Se areal density of FIG. 4 (d) from the Se areal density of FIG. 4 (c). The areal density of caspase-3 protein bound to the seleno-BIR-23 protein chip is 4.8×10¹¹/cm², and the binding efficiency is only 1%.

Since BIR-23 protein is a zinc-containing protein (The zinc ion serves as a structural element), containing two Zn atoms per protein, Zn peaks were also depicted in FIGS. 4 (b) to 4 (d) along with the Se peaks. Of course, the areal density of the BIR-23 protein fixed on the chip or the areal density of the BIR-23 protein binding to the caspase-3 protein may be computed from the Zn peak.

However, when measuring the areal density of a protein fixed on a protein chip and the binding efficiency between the fixed protein and a different protein, as in FIG. 4, it is preferable to utilize the change of areal density of an element existing in both proteins.

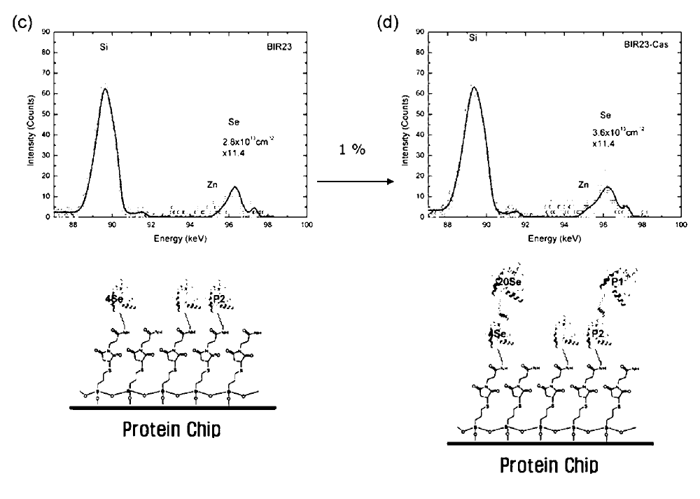

In accordance with the present invention, the quantity of DNA fixed on a chip can be quantified very precisely. FIG. 5 schematically shows a DNA microarray prepared in Preparation Example 3. In FIG. 5, the rectangle indicates the region where H⁺ ion has been injected. MEIS spectrum was obtained from four DNA spots having a diameter of 100 μm.

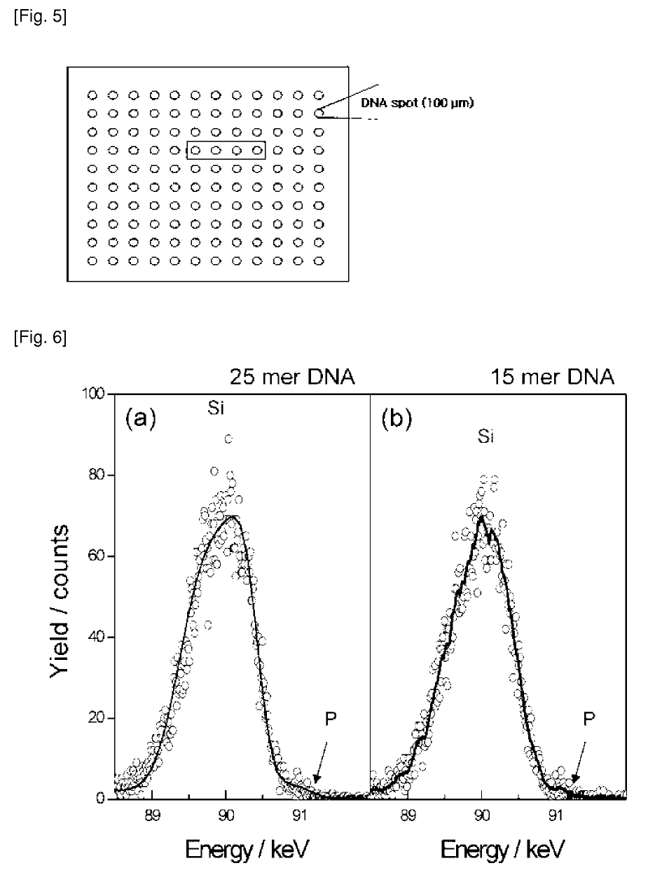

FIG. 6 shows MEIS spectrums obtained from the DNA microarray. FIG. 6 (a) shows an MEIS spectrum of a DNA microarray on which 25-mer DNA is sprayed. FIG. 6 (b) shows an MEIS spectrum of a DNA microarray on which 15-mer DNA is sprayed.

The number of DNA strands per each spot was determined based on the areal density of P. Since there are four spots in the MEIS measurement region, the P areal density for each spot is obtained by dividing the areal density by 4. And, since each DNA strand contains one P atom per each mer, the number of DNA strands per each spot may be computed by dividing by the number of mers. This can be expressed by Equation 1.

$$Number of DNA strands per aspot = ( \frac{Density of P ( {cm}^{- 2} )}{Number of DNA mer} ) spot area ( {cm}^{2} ) \qquad ( Equation 1 )$$

In Equation 1, ‘Number of DNA strand per spot’ refers to the number of DNA strands per each spot, ‘Density of P’ refers to the areal density of P measured by MEIS, ‘Number of DNA mer’ refers to the number of mers constituting a DNA strand, and ‘Spot area’ refers to the area of one spot.

The number of 25-mer and 15-mer DNA strands per each spot was computed as 1.054×10⁹ and 9.687×10⁸, respectively. Since the concentration of the DNA solution was the same, the number should be the same. The error of determination is 8.1%, within the allowable MEIS error range (˜10%).

Similarly to the example of measuring the areal density of a protein and the binding efficiency of proteins on a protein chip described referring to FIG. 4, the areal density of a probe DNA and the binding efficiency between the probe DNA and a target DNA binding complementarily thereto may be computed very precisely in accordance with the present invention.

By inducing hybridization using the single-strand DNA chip (III) prepared in Preparation Example 4 and DNA having a complementary base sequence, MEIS spectrum can be obtained from the double-strand DNA chip (IV). Further, the number of DNAs and the binding efficiency thereof can be accurately computed based on the areal density P before and after the hybridization. As in Preparation Example 4, the ethylenediamine (PPEDA) with a final thickness of several nanometers formed between the silicon substrate and the DNA molecules effectively separate the Si peak and the P peak on the MEIS spectrum, thereby enabling accurate measurement.

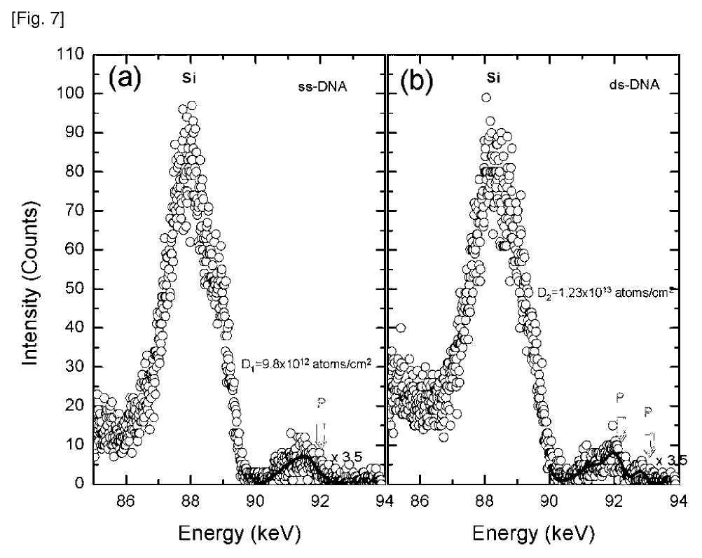

FIG. 7 shows MEIS spectrums obtained from the DNA chip. FIG. 7 (a) shows an MEIS spectrum obtained from the single-strand DNA chip (III). FIG. 7 (b) shows an MEIS spectrum obtained from the double-strand DNA chip (IV). In FIG. 7, the P peak is enlarged by 3.5 times (×3.5).

As seen from FIGS. 7 (a) and 7(b), the density of the probe DNA and the DNA binding complementarily thereto is 9.8×10¹² atoms/cm² and 1.23×10″ atoms/cm², respectively, which was computed from the density of P considering the number of DNA mers. The binding efficiency is calculated by Equation 2 as 26%.

$$Hybridization Efficiency ( \% ) = \frac{Density of hybridized complement DNA}{Density of probe DNA} \times 100 \qquad ( Equation 2 )$$

In Equation 2, ‘Hybridization efficiency (%)’ refers to the binding efficiency, ‘Density of hybridized complement DNA’ refers to the areal density of the complementarily binding DNA, and ‘Density of probe DNA’ refers to the areal density of the fixed probe DNA.

Initially, the probe DNA strands fixed on the SAM have a very high density of about 1/10 that of the SAM. This affects the low binding efficiency. As such, by accurately computing the density of DNA before and after binding and quantitatively computing the binding efficiency, a condition for improving the binding efficiency may also be established.

The present application contains subject matter related to Korean Patent Application Nos. 10-2008-0081887 and 10-2009-0074209, filed in the Korean Intellectual Property Office on Aug. 21, 2008 and Aug. 12, 2009, the entire contents of which is incorporated herein by reference.

While the present invention has been described with respect to the specific embodiments, it will be apparent to those skilled in the art that various changes and modifications may be made without departing from the spirit and scope of the invention as defined in the following claims.

1. A method for quantification of biochemical substances, wherein the areal density (number per area) of an analyte including a biochemical substance bound to a substrate surface is measured using ion scattering spectroscopy (ISS).

2. The method for quantification of biochemical substances according to claim 1, wherein the ISS is medium-energy ion scattering spectroscopy (MEIS).

3. The method for quantification of biochemical substances according to claim 2, which comprises:
injecting accelerated proton (H⁺) to a predetermined area of a substrate surface on which an analyte is present and detecting the energy of scattered proton and the amount of scattered proton thereof;
computing the areal density (atoms per area) of a first element included in the analyte at the predetermined area from the detected energy of proton and amount of scattered proton; and
computing the areal density (number per area) of the analyte from the areal density of the first element included in the analyte.

4. The method for quantification of biochemical substances according to claim 3, wherein the areal density of the analyte is computed by dividing the areal density of the first element by a number of the first elements included in the analyte.

5. The method for quantification of biochemical substances according to claim 3, wherein the analyte is present in the form of a layer on the predetermined area of the substrate surface.

6. The method for quantification of biochemical substances according to claim 3, further comprising, prior to said injecting the accelerated proton, contacting the analyte on the substrate with a metal precursor solution so that the metal ion of the metal precursor may bind to the analyte.

7. The method for quantification of biochemical substances according to claim 3, wherein the analyte comprises:
a self-assembled monolayer (SAM) formed on the surface of the substrate; organic polymers, organometallic compounds, peptides, carbohydrates, proteins, protein complexes, lipids, metabolites, antigens, antibodies, enzymes, substrates, amino acids, aptamers, sugars, nucleic acids, nucleic acid fragments, peptide nucleic acids (PNAs), cell extracts, or a combination thereof fixed to the functional group of the SAM self-assembled on the substrate surface; nucleic acids complementarily binding to the nucleic acids fixed to the functional group of the SAM self-assembled on the substrate surface; proteins specifically binding to the proteins fixed to the functional group of the SAM self-assembled on the substrate surface; substrates specifically binding to the enzymes fixed to the functional group of the SAM self-assembled on the substrate surface; or antibodies specifically binding to the antigens fixed to the functional group of the SAM self-assembled on the substrate surface; or
organic polymers, organometallic compounds, peptides, carbohydrates, proteins, protein complexes, lipids, metabolites, antigens, antibodies, enzymes, substrates, amino acids, aptamers, sugars, nucleic acids, nucleic acid fragments, PNAs, cell extracts, or a combination thereof bound at the surface of the substrate; nucleic acids complementarily binding to the nucleic acids bound at the substrate surface; proteins specifically binding to the proteins bound at the substrate surface; substrates specifically binding to the enzymes bound at the substrate surface; or antibodies specifically binding to the antigens bound at the substrate surface.

8. The method for quantification of biochemical substances according to claim 6, wherein the analyte comprises a self-assembled monolayer (SAM), and the metal ion binds to sulfur included in the SAM.

9. The method for quantification of biochemical substances according to claim 3, wherein the analyte comprises a nucleic acid, and the first element is P.

10. The method for quantification of biochemical substances according to claim 3, wherein the substrate is a semiconductor single crystal substrate including a silicon single crystal substrate, a semiconductor single crystal substrate having a surface oxide layer, an amorphous substrate including a glass substrate, a metal oxide single crystal substrate including a silica single crystal substrate, or a laminated substrate thereof.

11. A method for quantification of binding efficiency of biochemical substances, wherein the areal density of a first biochemical substance fixed on a substrate is measured using ion scattering spectroscopy (ISS), the areal density of a second biochemical substance binding to the first biochemical substance is measured using ISS, and the binding efficiency between the first biochemical substance and the second biochemical substance is computed by dividing the areal density of the second biochemical substance by the areal density of the first biochemical substance.

12. The method for quantification of binding efficiency of biochemical substances according to claim 11, wherein the ISS is MEIS, and the method comprises:
injecting accelerated proton (H⁺) to a predetermined area of a substrate surface on which a first biochemical substance is present and detecting the energy of scattered proton and an the amount of scattered proton thereof;
computing the areal density (atoms per area) of a second element included in the first biochemical substance at the predetermined area from the detected energy of proton and amount of scattered proton;
computing the areal density (number per area) of the first biochemical substance from the areal density of the second element included in the first biochemical substance;
injecting accelerated proton (H⁺) to the predetermined area of the substrate surface on which the first biochemical substance in contact with a second biochemical substance is present, and detecting the energy of scattered proton and the amount of scattered proton thereof;
computing the areal density (atoms per area) of a third element included in the second biochemical substance at the predetermined area from thus detected energy of proton and amount of scattered proton;
computing the areal density (number per area) of the second biochemical substance from the areal density of the third element included in the second biochemical substance; and
computing the binding efficiency between the first biochemical substance and the second biochemical substance by dividing the areal density of the second biochemical substance by the areal density of the first biochemical substance.

13. The method for quantification of binding efficiency of biochemical substances according to claim 12, wherein the second element and the third element are the same element present in both the first biochemical substance and the second biochemical substance.

14. The method for quantification of binding efficiency of biochemical substances according to claim 12, wherein the second element and the third element are different from each other, and one element selected from the second element and the third element is present only in the first biochemical substance or the second biochemical substance.

15. The method for quantification of binding efficiency of biochemical substances according to claim 12, wherein the binding between the first biochemical substance and the second biochemical substance is a specific binding such as enzyme-substrate, antigen-antibody, protein-protein or nucleic acid-nucleic acid binding.
